(19) United States
(12) Patent Application Publication
(10) Pub. No.: US 2014/0000435 A1
(43) Pub. Date: Jan. 2, 2014

(54) Integrated Guitar Pick Holder With Guitar Picks

(71) Applicant: Mark Benjamin Wald, Manhattan Beach, CA (US)

(72) Inventor: Mark Benjamin Wald, Manhattan Beach, CA (US)

(21) Appl. No.: 13/539,732

(22) Filed: Jul. 2, 2012

(51) Int. Cl. G10D 3/16

(52) U.S. Cl. CPC G10D 3/163
USPC 84/322

(57) ABSTRACT

The present invention discloses an integrated guitar pick holder with guitar picks. Said integrated guitar pick holder with guitar picks is comprised of a guitar pick holder which is a thin medium and guitar picks that are attached to said thin medium holder. Said guitar picks are secured by the said thin medium holder to form an integrated one piece by either not completely cutting out the picks but leaving connection between said picks and said holder and at the same time allowing individual picks to be removable from said holder, or by completely cutting out the picks and then adhering said picks to a thin film applied to one side of said holder, or by adhering separately manufactured picks to the surface of said holder, thereby creating an integrated unit comprised of both guitar picks and holder. The present invention may be made to the size and shape of a credit card, thus users may store and carry it in their wallets.

### BACKGROUND OF THE INVENTION

### FIELD OF THE INVENTION

The present invention relates to a guitar pick holder. More particularly it related to an integrated guitar pick holder with guitar picks.

Guitar players use guitar pick to strum or pluck the strings of a guitar. A guitar pick is generally a triangular-shaped disc which is made of thin, hard, yet still somewhat flexible materials. Guitar picks usually are small, and sized to be held between the thumb and first finger. Guitar picks are typically carried in pants pockets and/or within guitar cases and they are very easily dropped, lost and misplaced.

There have been attempts to solve this problem in various ways. One way is to add additional features to guitar picks themselves. For example, U.S. Pat. No. 6,835,881 B1 to Jackson discloses a guitar pick having a key ring hold for selective attachment to a key ring. U.S. Pat. No. 7,459,620 B1 to Kester discloses a guitar pick with a central opening. The slotted central opening allows the pick to be snapped onto and off of pegs and posts on the guitar for storage and retrieval. Another way is to use guitar pick holders.

For example, U.S. Pat. No. 4,135,431 to Ferguson shows a spring loaded pick dispenser similar to a coin dispenser, wherein the picks can only be accessed sequentially. U.S. Pat. No. 6,215,052 to Giddens et al. discloses a guitar pick holder with plurality of slots arranged on the front half for receiving guitar picks. U.S. PreGrant Publication No. US2011/0100192 to Zink et al. discloses a credit card shaped guitar pick holder with slots or pockets to hold guitar picks and the holder can be kept in player's wallet.

### SUMMARY OF THE INVENTION

In an exemplary embodiment of the present invention, there is disclosed a guitar pick holder. More particularly it related to an integrated guitar pick holder with guitar picks.

In the present invention, the integrated guitar pick holder with guitar picks is comprised of a guitar pick holder which is a thin medium and guitar picks that are integrated with and secured to the said thin medium holder. The guitar picks may either be cut out from the said thin medium holder or be attached to a thin medium holder made of another material, thereby creating an integrated unit comprised of both guitar picks and holder.

In one embodiment of the present invention, said holder and said picks are made from one thin medium blank. Guitar picks with desirable shape are cut out from said medium blank, leaving part of the pick attached to said blank. The picks can be broken off from said medium whenever it is needed by guitar players. With the same concept of the present invention, a hot stamp or injection mold can be used to form individual, removable guitar picks from said thin medium. In this way, said holder and said guitar picks are integrated into one piece of thin medium, wherein individual picks are breakable off the integrated piece.

In another embodiment of the present invention, said medium has holes already cut out in the appropriate size and shape to allow a similar size and shape pick to be inserted. Said medium may either be of the same material as the guitar picks or a different material. A thin film with removable adhesive is applied to one side of the card and adhered to a pick inserted in each of the holes in the said medium. The user can remove a pick whenever needed, leaving the rest of the picks in place.

In yet another embodiment of the present invention, guitar picks which are manufactured by a separate and independent process are subsequently attached to the surface of a thin medium holder using removable adhesive, thereby creating an integrated unit comprised of both guitar picks and holder. The user can remove a pick whenever needed, leaving the rest of the picks in place.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows.

Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1A, FIG. 1B, FIG. 1C and FIG. 1D are illustrations of said present invention of an integrated guitar pick holder with picks.

FIG. 2A and FIG. 2B are illustrations of said present invention using a sticky film medium.

FIG. 3 is a blow-up image of the present invention of an integrated guitar pick holder with holes cut out, with a thin film with adhesives attached to one side of the holder, and with picks adhered to said thin film.

### DESCRIPTION OF THE PREFERRED EMBODIMENT

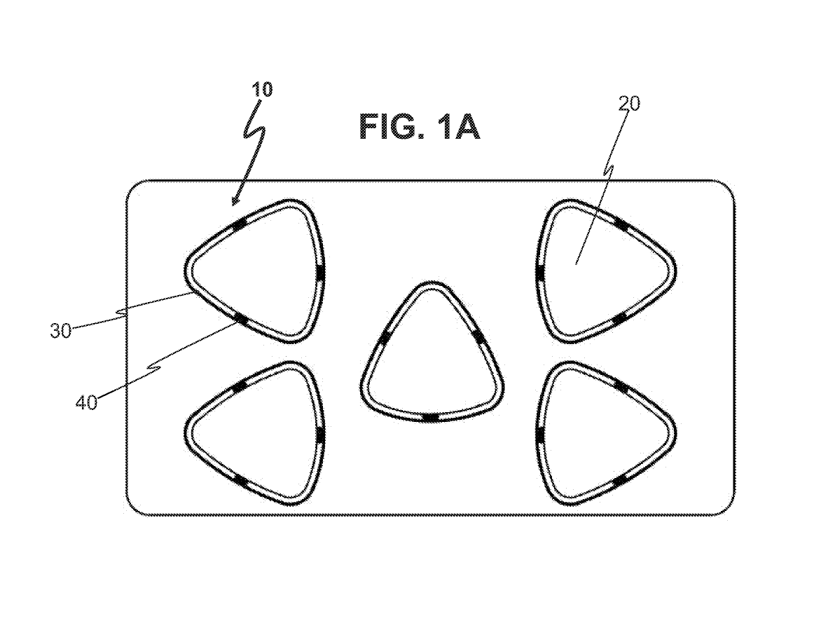

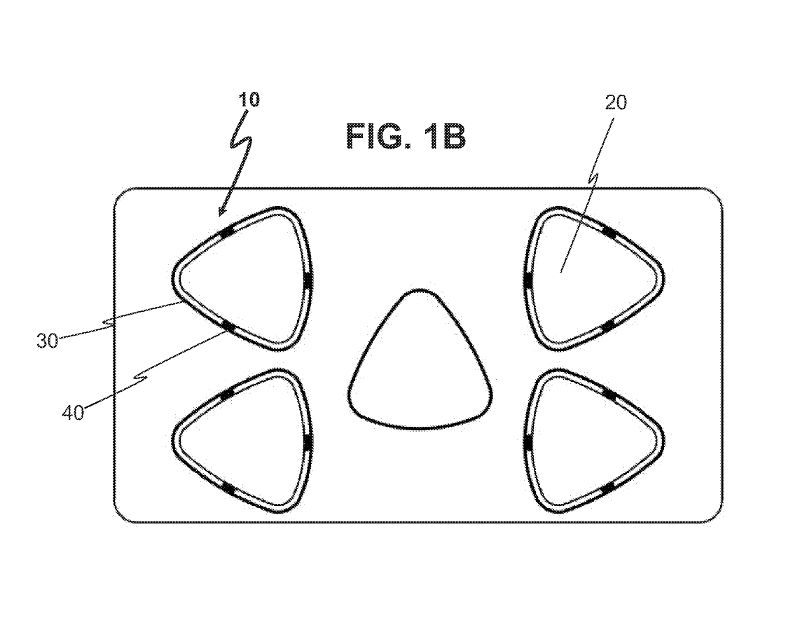

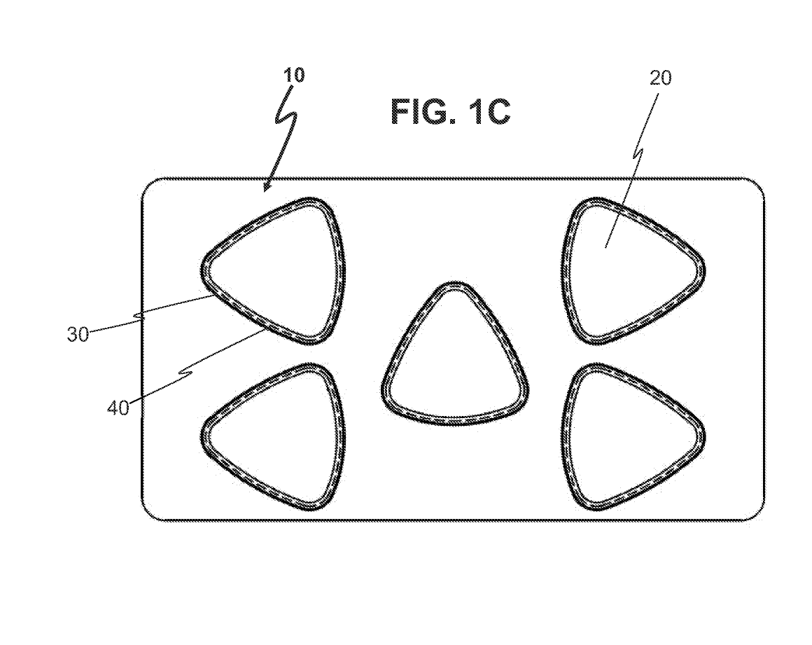

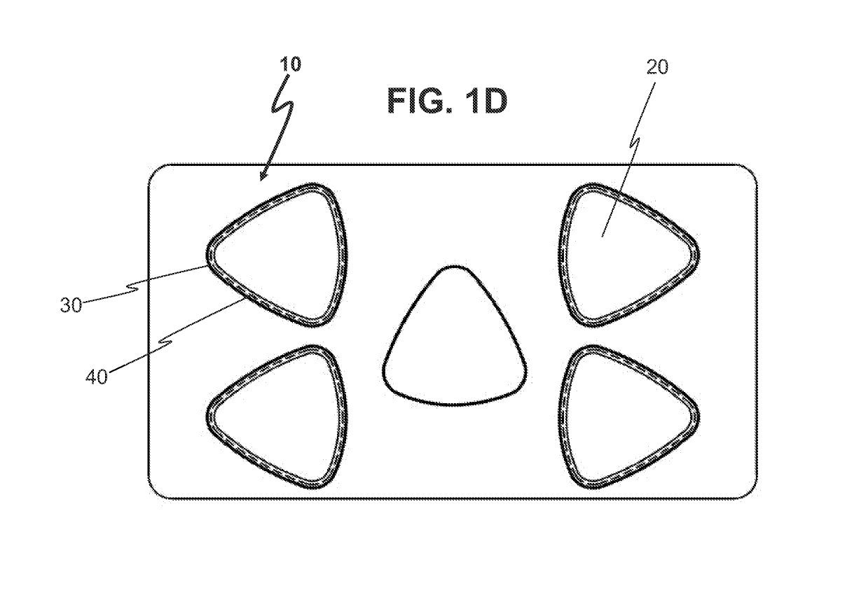

Referring to FIG. 1A, there is disclosed an integrated guitar pick holder with guitar picks comprising of a guitar pick holder which is a thin medium and guitar picks that are cut out from the said thin medium holder and are integrated with and secured by the said thin medium holder.

Guitar picks 20 are cut out from a thin medium 10. Said picks can be formed either by die cut, laser cut, or other cut, or they can be formed by using a hot stamp or injection mold. When making said picks 20 from said medium 10, said medium may be cut through but leaving a few spots 40 which connect the resulting holes 30 and picks 20 as shown FIG. 1A. In this way, said thin medium as a guitar pick holder and guitar picks are integrated into one piece. Individual guitar pick can be broken off the said holder whenever it is needed. As shown in FIG. 1B, one pick is taken off from the said thin medium holder and left a hold on said medium, while other picks are still on the medium. The said medium may also not be cut through, and in this way, the picks 20 are connected to the resulting holes 30 by a continuous connection 40 as shown in FIG. 1C. But the cut needs to be deep enough to allow individual pick removable from the said medium. As shown in FIG. 1D, one pick is taken off from the said thin medium holder and left a hole on said medium, while other picks are still on the medium.

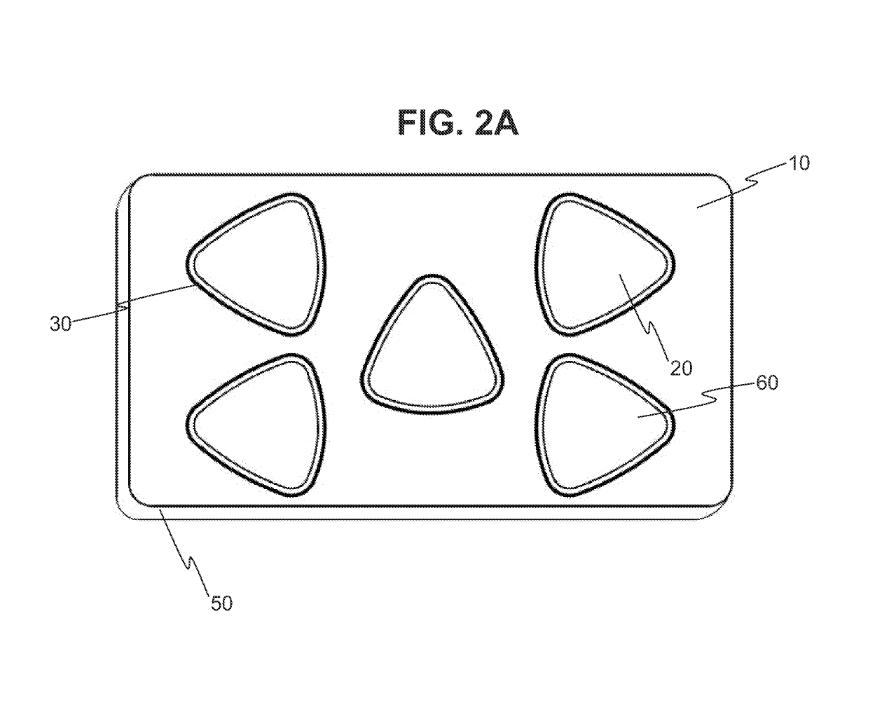

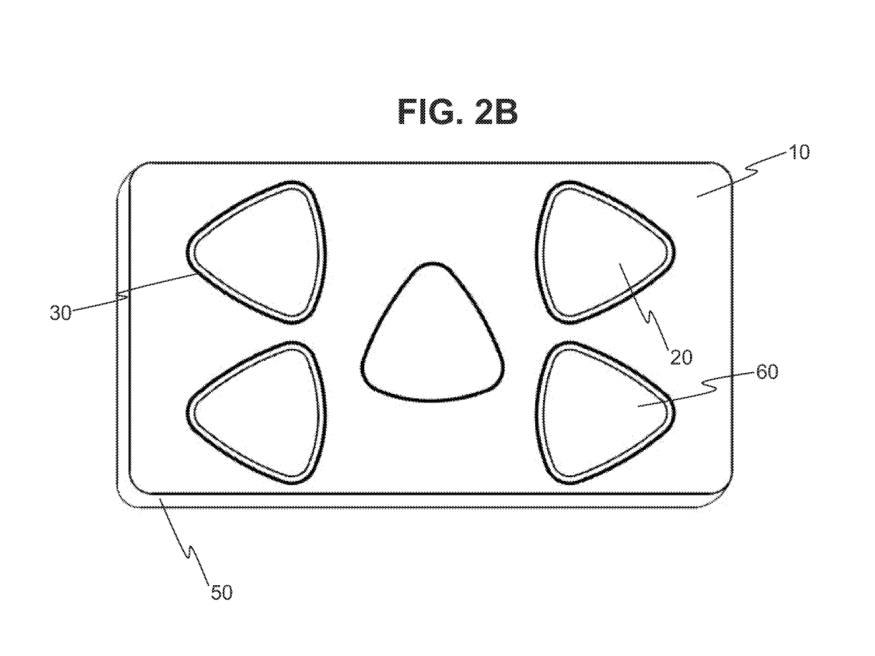

In another embodiment of the present invention, as shown in FIG. 2A, holes 30 with desirable size and shape are cut out on a thin medium holder 10. A thin film 50 is applied to one side of said thin medium holder 10. Adhesives 60 are coated on the side of thin film contacting said thin medium holder. Picks 20 with similar size and shape as said holes are inserted in the holes and adhered to the adhesives on the thin film. FIG. 2B shows that an individual pick is removed from the said thin medium holder. After playing, the pick can be placed back to its original place, if the user choose to.

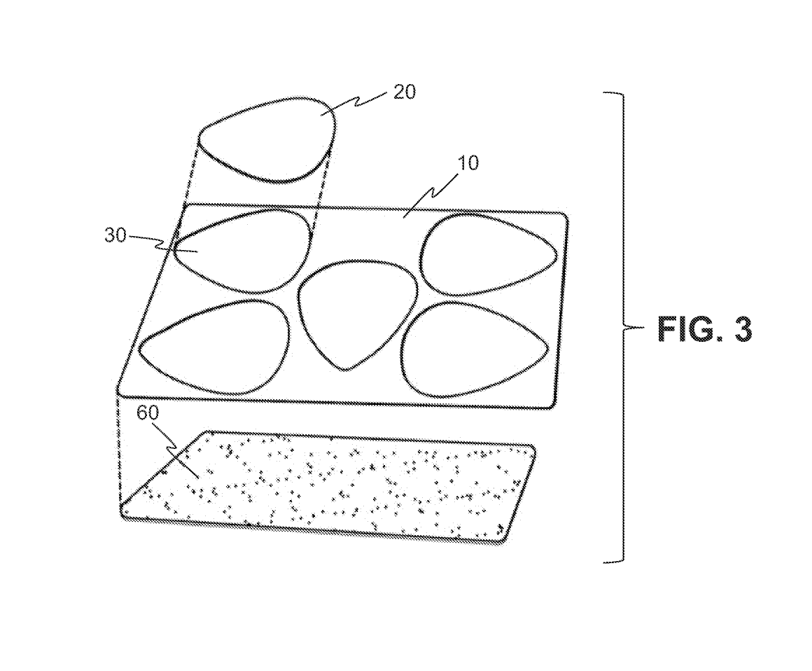

FIG. 3 shows a blow up presentation of FIGS. 2A and 2B where said adhesive 60 is not yet attached to thin medium holder 10. Additionally, this figure shows pick 20 away from medium holder 10 and detached from hole opening 30. It is possible with this embodiment for a user to attach any pick that will fit within opening 30 and not just a pick that has been presented with the current invention. In this way, if a user has lost a pick and buys a replacement pick, such replacement item will be able to function within this embodiment of said invention.

In one embodiment of the present invention, the thin medium holder is in the size and shape of a credit card. Thus users may place and carry the present invention in their wallets.

In one embodiment of the present invention, the thin medium is made from polymer materials, plastic or any materials suitable for making guitar picks.

In one embodiment of the present invention, the thickness of said thin medium varies, so long as it is suitable for guitar picks.

In one embodiment of the present invention, said thin medium may be different colors and may have various printed patterns on it.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. An integrated guitar pick holder with guitar picks comprising:
a. a thin medium holder; and
b. guitar picks;
wherein said guitar picks are integrated with and secured by said thin medium holder.

2. An integrated guitar pick holder with guitar picks of claim 1, wherein said thin medium holder is in a size and shape of a credit card.

3. An integrated guitar pick holder with guitar picks of claim 2, wherein said guitar picks are cut out from said thin medium holder by die cut, laser cut, or other ways of cutting, or by hot stamp or injection mold.

4. An integrated guitar pick holder with guitar picks of claim 3, wherein said guitar picks are cut out from said thin medium holder in such a way that a few spots are left connecting with said thin medium holder, and individual pick is removable from said thin medium holder.

5. An integrated guitar pick holder with guitar picks of claim 4, wherein said thin medium is made from polymer materials, plastic and any materials suitable for guitar picks.

6. An integrated guitar pick holder with guitar picks of claim 5, wherein said thin medium is in different colors, decorated with different printed patterns, and in suitable thickness for guitar picks.

7. An integrated guitar pick holder with guitar picks of claim 3, wherein said guitar picks are cut out from said thin medium holder in such a way that said thin medium holder is not cut through, but deep enough to allow individual pick to be removable from said thin medium holder.

8. An integrated guitar pick holder with guitar picks of claim 7, wherein said thin medium is made from polymer materials, plastic and any materials suitable for guitar picks.

9. An integrated guitar pick holder with guitar picks of claim 8, wherein said thin medium is in different colors, decorated with different printed patterns, and in suitable thickness for guitar picks.

10. An integrated guitar pick holder with guitar picks of claim 3, further comprising a thin film applied to one side of said thin medium holder; and wherein said thin film is coated with adhesives on the side contacting said thin medium holder; said guitar picks are adhered to said thin film.

11. An integrated guitar pick holder with guitar picks of claim 10, wherein said adhesives may either be one-time use only or reusable.

12. An integrated guitar pick holder with guitar picks of claim 11, wherein said thin medium is made from polymer materials, plastic, paper or any other material.

13. An integrated guitar pick holder with guitar picks of claim 12, wherein said thin medium is in different colors, decorated with different printed patterns, and in suitable thickness for guitar picks.

14. An integrated guitar pick holder with guitar picks of claim 2, wherein said guitar picks are manufactured by a separate and independent process and then subsequently attached to the surface of a thin medium holder using removable adhesive thereby creating an integrated unit comprised of both guitar picks and holder.

15. An integrated guitar pick holder with guitar picks of claim 14, wherein said adhesives may either be one-time use only or reusable.

16. An integrated guitar pick holder with guitar picks of claim 15, wherein said thin medium is made from polymer materials, plastic, paper or any other material.

17. An integrated guitar pick holder with guitar picks of claim 16, wherein said thin medium is in different colors, decorated with different printed patterns, and in suitable thickness for guitar picks.
